(19) United States
(12) Patent Application Publication
(10) Pub. No.: US 2017/0286092 A1
(43) Pub. Date: Oct. 5, 2017

(54) TERMINAL DEVICE AND VERSION UPGRADING METHOD

(71) Applicants: HISENSE MOBILE COMMUNICATIONS TECHNOLOGY CO., LTD., Shandong (CN); HISENSE USA CORPORATION, Suwanee, GA (US); HISENSE INTERNATIONAL CO.,LTD., Shandong (CN)

(72) Inventors: Xiaoliang ZHU, Shandong (CN); Zimin SHI, Shandong (CN); Minglin ZHONG, Shandong (CN)

(21) Appl. No.: 15/220,977

(22) Filed: Jul. 27, 2016

(30) Foreign Application Priority Data
Mar. 29, 2016 (CN) 201610187359.3

(51) Int. Cl. G06F 9/445; G06F 17/30; G06F 11/14

(52) U.S. Cl. CPC G06F 8/665; G06F 11/1451; G06F 17/30569; G06F 2201/84

(57) ABSTRACT

Some embodiments of this disclosure provide a terminal device and a version upgrading method. The method includes: partitioning a user data partition of the terminal device into a formatted partition and a data retention partition upon reception of an upgrade instruction to upgrade a current version of a software system of the terminal device; backuping user data in the formatted partition into the data retention partition; formatting the formatted partition; obtaining an upgrade package corresponding to a target version of the software system, and upgrading the current version of the software system of the terminal device to the target version using the upgrade package; and processing compatibility of user data in the data retention partition using the target version so that processed user data are compatible with the target version, and storing the processed user data into the formatted partition.

### CROSS-REFERENCE TO RELATED APPLICATION

This application claims priority to Chinese Patent Application No. 201610187359.3, filed on Mar. 29, 2016, which is hereby incorporated by reference in its entirety.

### FIELD

This disclosure relates to the field of communications, and particularly to a terminal device and a version upgrading method.

### BACKGROUND

At present, the majority of terminal devices (e.g., mobile terminals, tablet computers, etc.) are provided with software systems, and the software systems in the terminal devices in use can be upgraded to thereby optimize the performance of the terminal devices, that is, the versions of the terminal devices can be upgraded.

### SUMMARY

Some embodiments of this disclosure provide a terminal device including a nonvolatile memory and one or more processors, wherein one or more computer readable program codes are stored in the memory, and the one or more processors are configured to execute the one or more computer readable program codes for:

partitioning a user data partition of the terminal device into a formatted partition and a data retention partition upon reception of an upgrade instruction to upgrade a current version of a software system of the terminal device; backuping user data in the formatted partition into the data retention partition; formatting the formatted partition to delete the user data in the formatted partition; obtaining an upgrade package corresponding to a target version of the software system, and upgrading the current version of the software system of the terminal device to the target version using the upgrade package; and processing compatibility of user data in the data retention partition using the target version (compatibility process) so that the processed user data are compatible with the target version, and storing processed user data into the formatted partition.

Some embodiments of this disclosure provide a terminal device including:

a partitioning module configured to partition a user data partition of the terminal device into a formatted partition and a data retention partition upon reception of an upgrade instruction to upgrade a current version of a software system of the terminal device;

a backup module configured to backup user data in the formatted partition into the data retention partition;

a formatting module configured to format the formatted partition to delete the user data in the formatted partition, after the user data in the formatted partition are backed up into the data retention partition;

an upgrading module configured to obtain an upgrade package corresponding to a target version of the software system, and to upgrade the current version of the software system of the terminal device to the target version using the upgrade package after the user data in the formatted partition are deleted; and

a compatibility-processing module configured to process compatibility of user data in the data retention partition using the target version so that the processed user data are compatible with the target version, and to store the processed user data into the formatted partition.

Some embodiments of this disclosure provide a version upgrading method applicable to a terminal device, the method includes:

partitioning a user data partition of the terminal device into a formatted partition and a data retention partition upon reception of an upgrade instruction to upgrade a current version of a software system of the terminal device, wherein user data are stored in the user data partition;

backuping the user data in the formatted partition into the data retention partition, and formatting the formatted partition to delete the user data in the formatted partition;

obtaining an upgrade package corresponding to a target version of the software system, and upgrading the current version of the software system of the terminal device to the target version using the upgrade package; and

processing compatibility of the user data in the data retention partition using the target version so that the processed user data are compatible with the target version, and storing processed user data into the formatted partition.

### BRIEF DESCRIPTION OF THE DRAWINGS

In order to make the technical solutions according to some embodiments of this disclosure more apparent, the drawings to which a description of the embodiments will be briefly introduced below, and apparently the drawings to be described below are merely illustrative of some of the embodiments of this disclosure, and those ordinarily skilled in the art can derive from these drawings other drawings without any inventive effort. In the drawings:

FIG. 1 is a schematic flow chart of a version upgrading method according to some embodiments of this disclosure;

FIG. 2 is a first schematic flow chart of a data backup method according to some embodiments of this disclosure;

FIG. 3 is a schematic diagram of a display interface of a terminal device according to some embodiments of this disclosure;

FIG. 4 is a second schematic flow chart of a data backup method according to some embodiments of this disclosure;

FIG. 5 is a schematic flow chart of a user data compatibility-processing method according to some embodiments of this disclosure;

FIG. 6 is a first schematic structural diagram of a terminal device according to some embodiments of this disclosure;

FIG. 7 is a second schematic structural diagram of a terminal device according to some embodiments of this disclosure;

FIG. 8 is a third schematic structural diagram of a terminal device according to some embodiments of this disclosure; and

FIG. 9 is a fourth schematic structural diagram of a terminal device according to some embodiments of this disclosure.

### DETAILED DESCRIPTION OF THE EMBODIMENTS

In order to make the objects, technical solutions, and advantages of some embodiments of this disclosure more apparent, the technical solutions according to some embodiments of this disclosure will be described below with reference to the drawings in the embodiments of this disclosure, and apparently the embodiments described below are only a part but not all of the embodiments of this disclosure. Based upon the embodiments here of this disclosure, all the other embodiments which can occur to those skilled in the art without any inventive effort shall fall into the scope of this disclosure.

A terminal device according to some embodiments of this disclosure includes a software system, and the terminal device can have the current version of the software system thereof upgraded, where the terminal device can include but will not be limited to a mobile phone, a tablet computer, etc. A version upgrading method and a terminal device according to this disclosure will be described below in connection with some embodiments thereof.

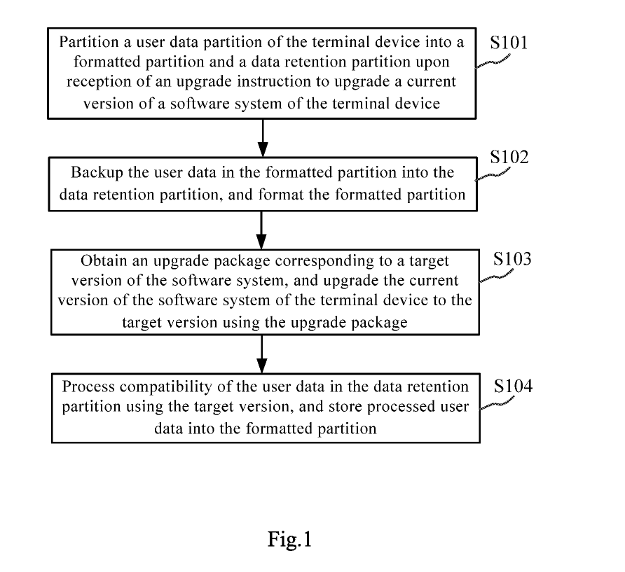

FIG. 1 is a schematic flow chart of a version upgrading method according to this disclosure, where an executor of this method is a terminal device, and referring to FIG. 1, the method can include:

S101 is to partition a user data partition of the terminal device into a formatted partition and a data retention partition upon reception of an upgrade instruction to upgrade a current version of a software system of the terminal device, where user data are stored in the user data partition;

S102 is to backup the user data in the formatted partition into the data retention partition, and to format the formatted partition to delete the user data in the formatted partition;

S103 is to obtain an upgrade package corresponding to a target version of the software system, and to upgrade the current version of the software system of the terminal device to the target version using the upgrade package; and

S104 is to process compatibility of the user data in the data retention partition using the target version so that the processed user data are compatible with the target version, and to store the processed user data into the formatted partition.

The terminal device includes the user data partition in which the user data are stored, where the user data include applications downloaded by a user, data generated by operating system applications of the terminal device, data generated by the operating application downloaded by the user, data copied by the user into the terminal device, etc., for example, the user data can include a phone book, communication entries, photographed or downloaded images, etc.

In some embodiments, during upgrading the version of the software system of the terminal device, the user can input the upgrade instruction into the terminal device, and optionally the upgrade instruction can be a click operation performed by the user on a preset button in the terminal device, and the terminal device can partition the user data partition of the terminal device into the formatted partition and the data retention partition upon reception of the upgrade instruction, where the sum of the capacity of the formatted partition and the capacity of the data retention partition is the capacity of the user data partition of the terminal device. The terminal device can partition the user data partition of the terminal device into the formatted partition and the data retention partition in reality. The data retention partition can be a phone U-disk of the terminal device, and the formatted partition is another data partition in the user data partition than the partition occupied by the phone U-disk, where data visible to the user are stored in the phone U-disk, e.g., images, videos, etc., photographed or downloaded by the terminal device, and accordingly data invisible to the user are stored in the formatted data, e.g., user data for displaying the communication entries.

After the user data partition is partitioned into the formatted partition and the data retention partition, the terminal device backups the user data in the formatted partition into the data retention partition, and format the formatted partition to delete the user data in the formatted partition. Firstly path information of the formatted partition can be obtained, and the user data partition can be formatted using the path information of the formatted partition to delete the user data in the formatted partition, and then the user data in the data retention partition can be retained.

After the user data in the formatted partition are backed up, the upgrade package corresponding to the target version of the software system is obtained. If the terminal device is upgraded fully, then the obtained upgrade package will be a full upgrade package corresponding to the target version; and if the terminal device is upgraded incrementally, then the obtained upgrade package will be a differential package between the current version and the target version of the terminal device, and after the upgrade package is obtained, the current version of the terminal device will be upgraded to the target upgrade using the upgrade package.

After the software system of the terminal device is upgraded to the target version, the user data need to be recovered, and the terminal device processes compatibility of the user data in the data retention partition. The user data in the data retention partition can be processed sequentially per folder so that the processed user data are compatible with the target version, and the processed user data are stored into the formatted partition, thus recovering the user data; and after the processed user data are stored into the formatted partition, the user data in the data retention partition can be deleted in order to save a storage space in the terminal device.

It shall be noted that after the version of the software system of the terminal device is upgraded, a data storage scheme of the data retention partition can be further changed. If the data retention partition is a phone U-disk of the terminal device, then if the terminal device is accessible to a single user before the version is upgraded, then the terminal device will not distinguish the user accessing the terminal device, so all the user data can be stored in the same directory; and if the terminal device is accessible to a number of users after the version is upgraded, then the terminal device will distinguish the users accessing the terminal device from each other, and store user data generated while the different users are accessing the terminal device, into different directories, for example, store user data generated while a user A is accessing the terminal device, into a directory A, and user data generated while a user B is accessing the terminal device, into a directory B.

In some embodiments, the user data can be backed up in the following two implementations:

In one of the implementations, the data are backed up while a recovery mode is being initialized;

In a real application, the version of the software system of the terminal device can be upgraded in the recovery mode, where the recovery mode can be initialized upon entering into the recovery mode, so the data can be backed up while the recovery mode is being initialized, including: if the current version of the terminal device is to be upgraded, then firstly the recovery mode in the current version of the software system of the terminal device will be upgraded. A preset function capable of backuping the user data in the formatted partition into the data retention partition can be loaded in the recovery mode of the current version, thus resulting in an intermediate version of the terminal device, so that the recovery mode in the intermediate version is capable of backuping the user data in the formatted partition into the data retention partition.

After the current version of the software system of the terminal device is upgraded to the intermediate version, the intermediate version is further upgraded to the target version; and firstly the recovery mode of the intermediate version can be initialized while the intermediate version is being upgraded to the target version, and since the recovery mode in the intermediate version is capable of backuping the user data in the formatted partition into the data retention partition, the terminal device keeps the recovery mode in the intermediate version capable of backuping the user data in the formatted partition into the data retention partition, while the recovery mode is being initialized, thus backuping the user data.

In another embodiment, an upgrade script is modified;

In some embodiments, the version of the software system of the terminal device needs to be upgraded by upgrading the version of the terminal device using the upgrade script, so the data can be backed up in the upgrade script, including: firstly the upgrade script is determined before the version of the software system is upgraded, so that the upgrade script is capable of backuping the user data in the formatted partition into the data retention partition, and the upgrade script is embodied as pseudo codes incapable of operating. The upgrade script can operate using a preset function; and in order to enable the terminal device to recognize the upgrade script, a script parser needs to be configured for the upgrade script so that the script parser can parse the upgrade script so that the terminal device can recognize the upgrade script.

Given the upgrade script and the upgrade script parser, a system partition and the user data partition of the terminal device are loaded in the recovery mode, and then the upgrade script is loaded into the script parser so that the script parse can parse the upgrade script; and the script parser is loaded into a memory in the recovery flow, and when the flow proceeds to the script parser, the user data in the formatted partition are backed up into the data retention partition to thereby backup the user data.

In the version upgrading method according to some embodiments of the disclosure, before the current version of the software system of the terminal device is upgraded, firstly the formatted partition and the data retention partition are determined in the user data partition of the terminal device, the user data in the formatted partition are backed up into the data retention partition, and the formatted partition is formatted, so that all the user data are backed up into the data retention partition, and the user data in the formatted partition are null; and then the current version of the software system of the terminal device is upgraded to the target version, and after the version is upgraded, compatibility of the user data in the data retention partition are processed sequentially, and the processed user data are stored into the formatted partition, so that the user data in the formatted partition are compatible with the target version, thus recovering the data. In the process above, after the current version of the software system of the terminal device is upgraded to the target version, the user data in the terminal device is retained, and also the user data in the terminal device are compatible with the target version, thus improving the experience of the user.

In the method illustrated in the embodiment of FIG. 1, the user data in the formatted partition can be backed up into the data retention partition (S102 in the embodiment illustrated in FIG. 1) in either of the following two implementations.

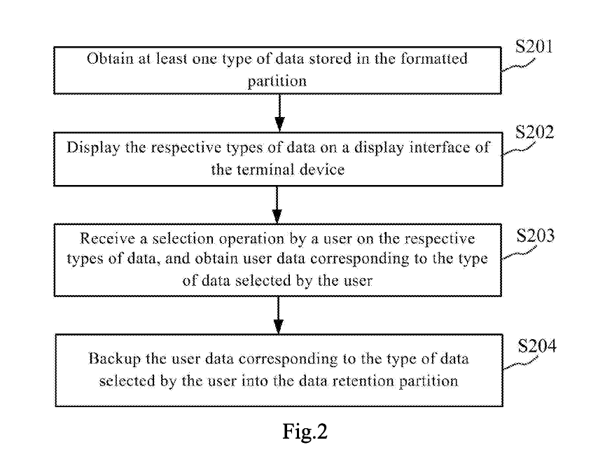

FIG. 2 is a first schematic flow chart of a data backup method according to some embodiments of this disclosure, and further to the some embodiments illustrated in FIG. 1, referring to FIG. 2, the method can include;

S201 is to obtain at least one type of data stored in the formatted partition;

S202 is to display the respective types of data on a display interface of the terminal device;

S203 is to receive a selection operation by the user on the respective types of data, and to obtain user data corresponding to the type of data selected by the user; and

S204 is to backup the user data corresponding to the type of data selected by the user into the data retention partition.

In the embodiment illustrated in FIG. 2, there is at least one type of data in the formatted partition. The type of data can correspond to a type of application, for example, all the user data generated by the operating WeChat application is of the type of WeChat data, all the user data generated by the operating Short Messaging application is of the type of short message data.

In some embodiments, if the user data in the formatted partition need to be backed up into the data retention partition, then the terminal device will obtain the respective types of data stored in the formatted partition, and display the respective types of data on the display interface of the terminal device. In order to enable the user to know the respective types of data, the respective types of data can be described so that the user can select one of the types of data to be backed up, as needed in reality, and after the selection operation by the user on the type of data, the user data corresponding to the type of data selected by the user can be obtained and backed up into the data retention partition.

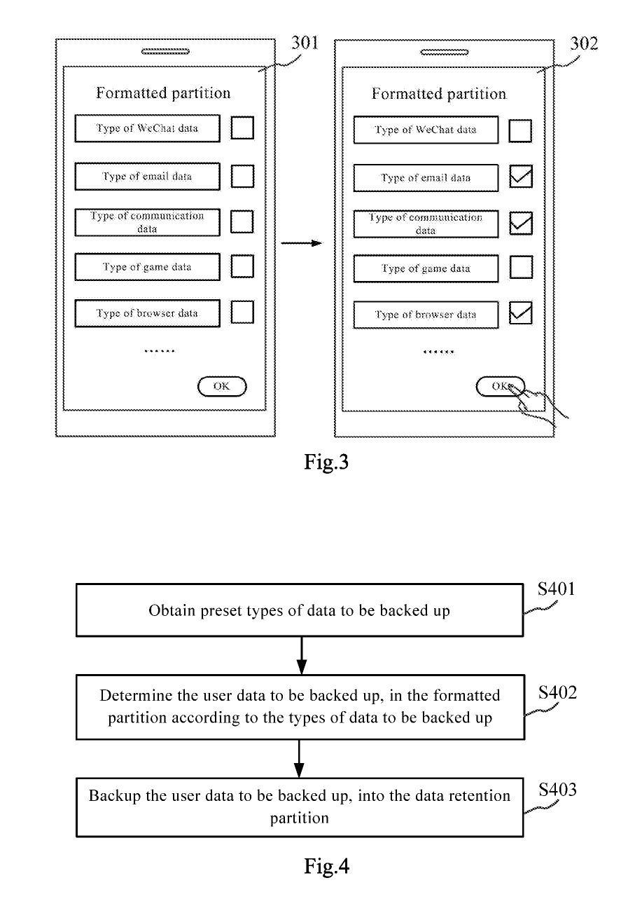

The method illustrated in the embodiment of FIG. 2 will be described below by way of an example in connection with the display interface of the terminal device illustrated in FIG. 3.

FIG. 3 is a schematic diagram of a display interface of the terminal device according to some embodiments of this disclosure, and referring to FIG. 3, the display interface includes an interface 301 and an interface 302.

The interface 301 includes types of data in the formatted partition, e.g., the type of WeChat data, the type of email data, the type of communication data, etc., illustrated in the interface 301; and further includes checkboxes corresponding to the respective types of data, and the user can perform a selection operation on the checkboxes.

In the interface 302, during backuping the user data in the formatted partition, the user can perform a selection operation on a checkbox corresponding to one of the types of data as needed in reality, for example, if the user needs to backup the email data, the communication data, and the browser data, then the user can perform selection operations on the checkboxes corresponding to the type of email data, the type of communication data, and the type of browser data, and click on a “OK” button in the interface 302, so that the terminal device can back up the user data corresponding to the type of email data, the type of communication data, and the type of browser data into the data retention partition.

In this embodiment the user can select the user data to be backed up, so that the terminal device will backup only the user data desirable to the user, thus avoiding the unwanted user data from being backed up so as to improve the efficiency of backuping the data.

FIG. 4 is another schematic flow chart of a data backup method according to some embodiments of this disclosure), and further to the embodiment illustrated in FIG. 1, referring to FIG. 4, the method can include:

S401 is to obtain preset types of data to be backed up;

S402 is to determine the user data to be backed up, in the formatted partition according to the types of data to be backed up; and

S403 is to back up the user data to be backed up, into the data retention partition.

In the method illustrated in the embodiment of FIG. 4, the preset types of data to be backed up can be preset in the terminal device, where the preset types of data to be backed up can include data of importance to the majority of users, e.g., phone book data, short message data, schedule data, etc.

If the user data in the formatted partition need to be copied into the data retention partition, then the terminal device will obtain the preset types of data to be backed up. A type of data to be backed up can correspond to a folder in which user data of the type of data to be backed up are stored. The terminal device can determine the user data to be backed up, corresponding to the types of data to be backed up, in all the folders in the formatted partition according to a correspondence relationship between the types of data to be backed up, and the folders, and then backup the user data to be backed up, into the data retention partition.

In some embodiments, if there are 10 folders in the formatted partition, which are denoted respectively as a folder 1 to a folder 10, each of which corresponds to a type of data to be backed up, and if the types of data to be backed up, preset in the terminal device include the phone text data, the short message data, the schedule data, and the email data, then the correspondence relationship between the preset types of data to be backed up, and the folders in the formatted partition may be depicted in Table 1:

TABLE 1

| Types of data to be | |
|---|---|
| backed up | Folders |
| Phone text data | Folder 2 |
| Short message data | Folder 4 |
| Schedule data | Folder 5 |
| Email data | Folder 9 |

The terminal device determines user data in the folder 2, the folder 4, the folder 5, and the folder 9 as user data to be backed up, in the folder 1 to the folder 10 according to the correspondence relationship between the types of data to be backed up, and the folders depicted in Table 1, and then backs up the user data to be backed up, into the data retention partition.

In some embodiments, the preset types of data to be backed up are preset in the terminal device so that the user can back up the user data in the formatted partition by determining automatically the data to be backed up, according to the preset types of data to be backed up, without any selection operation by the user, thus simplifying the operational flow of the user, and his or her operations so as to improve the experience of the user.

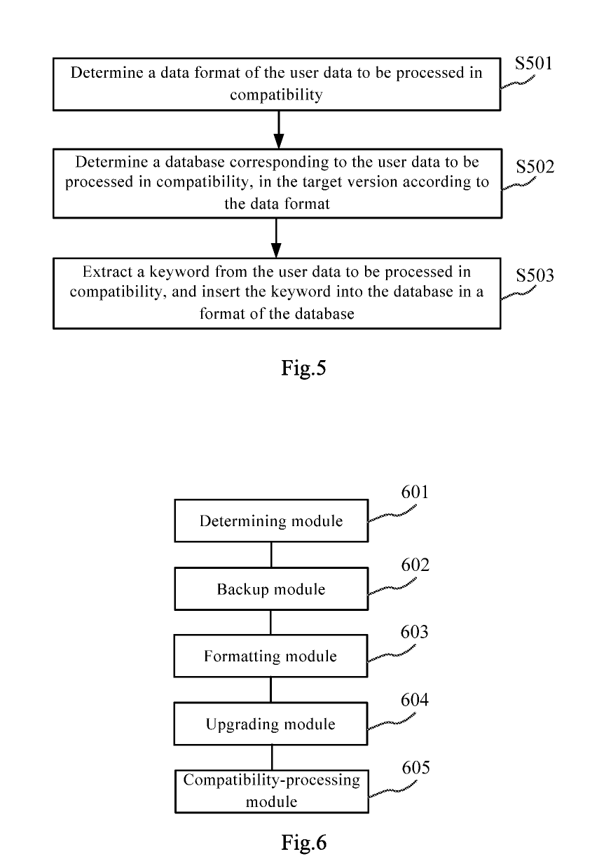

In some embodiments, compatibility of the user data in the data retention partition can be processed (S104 in the embodiment illustrated in FIG. 1) in the following implementation in the embodiment illustrated in FIG. 5.

FIG. 5 is a schematic flow chart of a method for processing compatibility of user data according to some embodiments of this disclosure, and referring to FIG. 5, the method can include:

S501 is to determine a data format of the user data to be processed in compatibility, which are any user data in the data retention partition;

S502 is to determine a database corresponding to the user data to be processed in compatibility, in the target version of the software system according to the data format; and

S503 is to extract a keyword from the user data to be processed in compatibility, and to insert the keyword into the database in a format of the database.

In some embodiments of this disclosure, each application includes a database corresponding thereto, and user data generated by the operating application is stored into the database, for example, the phone book application includes a database 1, and all the contacts input by the user while the phone book application is operating, is stored into the database 1 in a format of the database 1.

The terminal device can process compatibility of the user data in the data retention partition per folder, and since the terminal device process compatibility of all the user data in the same process, the compatibility process illustrated in the embodiment of FIG. 5 will be detailed below by way of an example in which the terminal device processes compatibility of the user data to be processed.

The terminal device determines data formats of the user data to be processed in compatibility, where the different data formats correspond to different databases, and the terminal device determines databases corresponding to the user data to be processed in compatibility, in the target version according to the data formats of the user data to be processed in compatibility, and then extracts keywords in the user data to be processed in compatibility, and inserts the keywords into the databases in the formats of the databases.

If the user data to be processed in compatibility are the phone book data, then if the terminal device stores contacts in a database 1 before the version of the terminal device is upgraded, where the database 1 includes attribute values of a contact name, a phone number, a type of number (home or office), and a note, then the contacts may be stored in the database 1 as depicted in Table 2:

TABLE 2

| Contact | Phone | Types of numbers (home or | |
|---|---|---|---|
| names | numbers | office) | Notes |
| Mr. Li | 111111 | Home | Call rejected later |
| | | | than 10 p.m. |
| Mr. Wang | 111112 | Office | Null |
| Mr. Zhang | 111113 | Office | Unanswered at |
| | | | weekend |
| Mr. Zhao | 11114 | Home | Null |
| . . . | . . . | . . . | . . . |

After the current version of the software system of the terminal device is upgraded, the terminal device processes compatibility of the photo book data by firstly determining the data format of the phone book, and determining a database 2 corresponding to the data format of the phone book in the target version of the software system, where if the database 2 includes attributes values of a contact name, a phone number, a type of number (home or office), and an email, then the terminal device will extract keyword data in the database 1 depicted in Table 2, and insert the keyword data into the database 2 in a format of the database 2, so that the database 2 is processed in compatibility as depicted in Table 3:

TABLE 3

| Contact | Phone | Types of numbers (home or | |
|---|---|---|---|
| names | numbers | office) | Email |
| Mr. Li | 111111 | Home | Null |
| Mr. Wang | 111112 | Office | Null |
| Mr. Zhang | 111113 | Office | Null |
| Mr. Zhao | 11114 | Home | Null |
| . . . | . . . | . . . | . . . |

In this implementation, since the user data are typically stored in the databases, the user data to be processed in compatibility can be processed according to the formats of the databases in the target versions so that the databases in the target version can be compatible with the processed user data to thereby ensure the target version to be compatible with the processed user data.

FIG. 6 is a first schematic structural diagram of a terminal device according to some embodiments of this disclosure, and referring to FIG. 6, the terminal device can include:

A partitioning module 601 is configured to partition a user data partition of the terminal device into a formatted partition and a data retention partition upon reception of an upgrade instruction to upgrade a current version of a software system of the terminal device, where user data are stored in the user data partition;

A backup module 602 is configured to backup the user data in the formatted partition into the data retention partition;

A formatting module 603 is configured to format the formatted partition to delete the user data in the formatted partition;

An upgrading module 604 is configured to obtain an upgrade package corresponding to a target version of the software system, and to upgrade the current version of the software system of the terminal device to the target version using the upgrade package; and

A compatibility-processing module 605 is configured to process compatibility of the user data in the data retention partition using the target version, and to store the processed user data into the formatted partition, where the processed user data are compatible with the target version.

In a real application, the backup module 602 can be configured:

To obtain at least one type of data stored in the formatted partition;

To display the respective types of data on a display interface of the terminal device;

To receive a selection operation by a user on the respective types of data, and to obtain user data corresponding to the type of data selected by the user; and

To backup the user data corresponding to the type of data selected by the user into the data retention partition.

The backup module 602 can be further configured:

To obtain preset types of data to be backed up;

To determine the user data to be backed up, in the formatted partition according to the types of data to be backed up; and

To back up the user data to be backed up, into the data retention partition.

The formatting module 603 can be configured:

To obtain path information of the formatted partition; and

To format the formatted partition according to the path information of the formatted partition to delete the user data in the formatted partition.

In a real application, the compatibility-processing module 605 can be configured:

To determine a data format of the user data to be processed in compatibility, which are any user data in the data retention partition;

To determine a database corresponding to the user data to be processed in compatibility, in the target version of the software system according to the data format; and

To extract a keyword from the user data to be processed in compatibility, and to insert the keyword into the database in a format of the database.

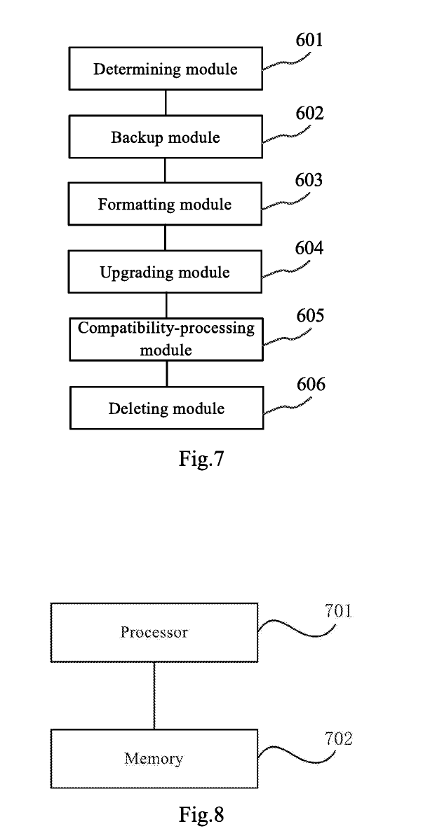

FIG. 7 is a second schematic structural diagram of a terminal device according to some embodiments of this disclosure, and further to the embodiment illustrated in FIG. 6, referring to FIG. 7, the terminal device can further include a deleting module 606, where:

The deleting module 606 is configured to delete the user data in the data retention partition after the compatibility-processing module stores the processed data into the formatted partition.

The terminal device according to the embodiments of the disclosure can perform the technical solutions according to the embodiments above of the methods under a similar principle while achieving similar advantageous effects, so a repeated description thereof will be omitted here.

FIG. 8 is a third schematic structural diagram of a terminal device according to some embodiments of this disclosure. As illustrated in FIG. 8, the terminal device includes one or more processors 701, and a nonvolatile memory 702 in which one or more computer readable program codes are stored, where the one or more processors are configured to execute the one or more computer readable program codes: to partition a user data partition of the terminal device into a formatted partition and a data retention partition upon reception of an upgrade instruction to upgrade a current version of a software system of the terminal device, where user data are stored in the user data partition; to backup the user data in the formatted partition into the data retention partition; to format the formatted partition to delete the user data in the formatted partition; to obtain an upgrade package corresponding to a target version of the software system, and to upgrade the current version of the software system of the terminal device to the target version using the upgrade package; and to process compatibility of the user data in the data retention partition using the target version, and to store the processed user data into the formatted partition, where the processed user data are compatible with the target version.

The one or more processors configured to execute the one or more computer readable program codes to backup the user data in the formatted partition into the data retention partition are configured: to obtain at least one type of data stored in the formatted partition; to display the respective types of data on a display interface of the terminal device; to receive a selection operation by a user on the respective types of data, and to obtain user data corresponding to the type of data selected by the user; and to backup the user data corresponding to the type of data selected by the user into the data retention partition.

The one or more processors configured to execute the one or more computer readable program codes to backup the user data in the formatted partition into the data retention partition are configured: to obtain preset types of data to be backed up; to determine the user data to be backed up, in the formatted partition according to the types of data to be backed up; and to back up the user data to be backed up, into the data retention partition.

The one or more processors configured to execute the one or more computer readable program codes to format the formatted partition to delete the user data in the formatted partition are configured: to obtain path information of the formatted partition; and to format the user data partition according to the path information of the formatted partition so that the user data in the formatted partition are null, and the user data in the data retention partition are retained.

The one or more processors configured to execute the one or more computer readable program codes to process compatibility of the user data in the data retention partition using the target version are configured: to determine a data format of the user data to be processed in compatibility, which are any user data in the data retention partition; to determine a database corresponding to the user data to be processed in compatibility, in the target version of the software system according to the data format; and to extract a keyword from the user data to be processed in compatibility, and to insert the keyword into the database in a format of the database.

The one or more processors are further configured to execute the one or more computer readable program codes to delete the user data in the data retention partition after the processed data are stored into the formatted partition.

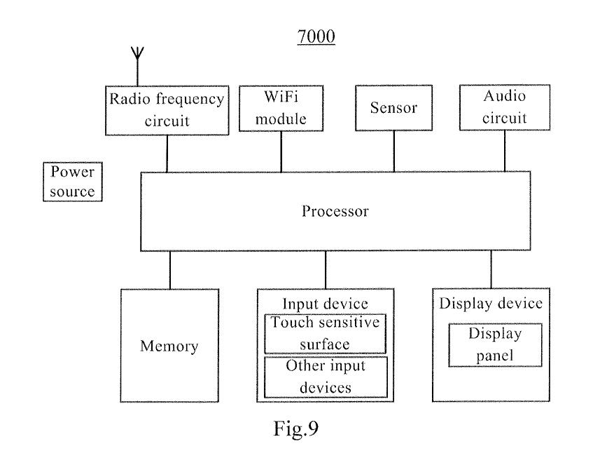

FIG. 9 is a fourth schematic structural diagram of a terminal device according to this disclosure. As illustrated in FIG. 9, the terminal device 6000 can be any one of various handheld devices (e.g., a mobile phone, a tablet computer, a PDA, etc.), which can include a processor including one or more processing cores, a radio frequency circuit, a memory including one or more computer readable storage mediums, an input device, a display device, a sensor, an audio circuit, a WiFi module, a power source and other components. Those skilled in the art can appreciate that the structure of the terminal device 6000 in this embodiment will not be intended to be limiting but can include more or fewer components or have some of the components combined or different components arranged, where:

The radio frequency circuit can be configured to receive and transmit a signal in the course of receiving and transmitting information or in communication, particularly by transferring downlink information of a base station to the one or more processors for processing upon reception of the downlink information; and also transmitting uplink data to the base station. Typically the radio frequency circuit includes but will not be limited to an antenna, at least one amplifier, a tuner, one or more oscillators, a Subscriber Identifier Module (SIM) card, a transceiver, a coupler, a Low Noise Amplifier (LNA), a duplexer, etc. Moreover the radio frequency circuit can further communicate with a network and another device through wireless communication. The wireless communication can comply with any of communication standards or protocols including but not limited to the GSM (Global System of Mobile communication), the GPRS (General Packet Radio Service), the CDMA (Code Division Multiple Access), the WCDMA (Wideband Code Division Multiple Access), the LTE (Long Term Evolution), an e-mail, the SMS (Short Messaging Service), etc.

The memory can be configured to store software programs and modules, and the processor is configured to run the software programs and modules stored in the memory to thereby perform various function applications and data processing. The memory can generally include a program storage partition and a data storage partition, where an operating system, applications required for at least one function (e.g., an audio playing function, an image playing function, etc.), etc., can be stored in the program storage partition; and data created for use of the terminal device 6000 (e.g., audio data, a phone book etc.), etc., can be stored in the data storage partition. Additionally the memory can include a high-speed random access memory and can further include a nonvolatile memory, e.g., at least one magnetic-disk memory device, a flash memory device or another volatile solid memory device. Correspondingly the memory can further include a memory controller configured to provide an access of the processor and the input device to the memory.

The input device can be configured to receive input digital or character information and to generate a keyboard, a mouse, a joystick, or an optical or track ball signal input related to user setting and function control. Particularly the input device can include a touch sensitive surface and another input device. The touch sensitive surface, also referred to as a touch display screen or a touch control pad, can be configured to collect a touch operation by a user thereon or in proximity thereto (e.g., an operation by the user on or in proximity to the touch sensitive surface using his or her finger, a stylus or any other appropriate object or attachment) and to drive a corresponding connected device by preset program. Optionally the touch sensitive surface can include two components which are a touch detection device and a touch controller, where the touch detection device detects the position of touching by the user, detects a signal as a result of the touch operation, and transfers the signal to the touch controller; and the touch controller receives the touch signal from the touch detection device and converts it into coordinates of a touch point and further transfers them to the processor, and can receive and execute a command sent by the processor. Moreover the touch sensitive surface can be embodied in various types of resistive, capacitive, infrared, surface sound wave and other types. The input device can further include another input device in addition to the touch sensitive surface. Particularly the other input device can include but will not be limited to one or more of a physical keyboard, functional keys (e.g., volume control press keys, a ON/OFF press key, etc.), a track ball, a mouse, a joystick, etc.

The display device can be configured to display information input by the user or information provided to the user and various graphic user interfaces of the terminal device 6000, where these graphic user interfaces can be composed of graphics, texts, icons, videos and any combination thereof. The display device can include a display panel which can be optionally configured in the form of a Liquid Crystal Display (LCD), an Organic Light-Emitting Diode (OLED) display, etc. Furthermore the touch sensitive surface can overlie the display panel, and the touch sensitive surface, upon detection of the touch operation thereon or in proximity thereto, transfers it to the processor to determine the type of the touch event, and thereafter the processor provides a corresponding visual output on the display panel according to the type of the touch event. Although the touch sensitive surface and the display device are embodied in this embodiment as two separate components to perform the input and output functions, the touch sensitive surface and the display device can be integrated to perform the input and output functions in some embodiments.

The terminal device 6000 can further include at least one sensor, e.g., an optical sensor, a motion sensor and other sensors. Particularly the optical sensor can include an ambient optical sensor and a proximity sensor, where the ambient optical sensor can adjust the brightness of the display panel according to the luminosity of ambient light rays, and the proximity sensor can power off the display panel and/or a backlight when the terminal device 6000 moves in proximity to an ear. A gravity acceleration sensor which is a motion sensor can detect the magnitudes of accelerations in respective directions (typically three axes) and can detect the magnitude and the direction of gravity when the sensor is stationary and can be configured to perform applications of identifying the posture of a handset (e.g., switching between landscape and portrait modes, relevant games, calibration of the posture of a magnetometer, etc.), a relevant function of identifying vibration (e.g., a pedometer, a knock, etc.), etc.; and the terminal device 6000 can be further configured with a gyroscope, a barometer, a hygrometer, a thermometer, an infrared sensor and other sensors, and a repeated description of these components will be omitted here.

The audio circuit, a speaker and a transducer can provide an audio interface between the user and the terminal device 6000. The audio circuit can convert received audio data into an electric signal and transmit the electric signal to the speaker, which is converted by the speaker into an audio signal for output; and on the other hand, the transducer converts a collected audio signal into an electric signal which is received by the audio circuit and then converted into audio data, and the audio data is further output to the processor for processing and then transmitted to another apparatus through the radio frequency circuit, for example, or the audio data is output to the memory for further processing. The audio circuit may further include an earphone jack for communication between a peripheral earphone and the terminal device 6000.

The WiFi falls into the category of short-range wireless transmission technologies, and the terminal device 6000 can assist the user in receiving and transmitting an e-mail, browsing a webpage, accessing streaming media, etc., through the WiFi module by which the user is provided with a wireless access to the broadband Internet. Although the WiFi module is illustrated in this embodiment, it can be appreciated that it may not be necessarily required for the terminal device 6000 but can be omitted as desired without departing from the scope of the disclosure.

The processor is a control component of the terminal device 6000, has the respective components connected by various interfaces and lines, and runs or executes the software programs and/or modules stored in the memory and invokes the data stored in the memory to perform the various functions of the terminal device 6000 and process the data to thereby manage and control the handset as a whole. Optionally the processor can include one or more processing cores; and preferably the processor can be integrated with an application processor and a modem processor, where the application processor generally handles the operating system, the user interfaces, the applications, etc., and the modem processor generally handles wireless communication. As can be appreciated, the modem processor above may not be integrated into the processor.

The terminal device 6000 further includes a power source (e.g., a battery) powering the respective components, and preferably the power source can be logically connected with the processor through a power management system to thereby perform charging and discharging management, power consumption management, etc., through the power management system. The power source can further include one or more DC or AC power sources, recharging systems, power source failure detection circuits, power source transformers or inverters, power source status indicators and any other components.

Although not illustrated, the terminal device 6000 can further include a camera, a Bluetooth module, etc., and a repeated description thereof will be omitted here. Particularly in this embodiment, the display device of the terminal device 6000 is a touch screen display, and the terminal device 6000 further includes a memory in which one or more programs are stored and configured to be executed by one or more processors.

Those ordinarily skilled in the art can appreciate that all or a part of the steps in the methods according to the embodiments described above can be performed by program instructing relevant hardware, where the programs can be stored in a computer readable storage medium, and the programs can perform one or a combination of the steps in the embodiments of the method upon being executed; and the storage medium includes an ROM, an RAM, a magnetic disc, an optical disk, or any other medium which can store program codes.

Lastly it shall be noted that the respective embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

1. A terminal device, comprising a nonvolatile memory and one or more processors, wherein one or more computer readable program codes are stored in the memory, and the one or more processors are configured to execute the one or more computer readable program codes for:
partitioning a user data partition of the terminal device into a formatted partition and a data retention partition upon reception of an upgrade instruction to upgrade a current version of a software system of the terminal device; backuping user data in the formatted partition into the data retention partition; formatting the formatted partition to delete the user data in the formatted partition; obtaining an upgrade package corresponding to a target version of the software system, and upgrading the current version of the software system of the terminal device to the target version using the upgrade package; and processing compatibility of user data in the data retention partition using the target version so that processed user data are compatible with the target version, and storing the processed user data into the formatted partition.

2. The terminal device according to claim 1, wherein the backuping the user data in the formatted partition into the data retention partition comprises: obtaining at least one type of data stored in the formatted partition; displaying the at least one type of data on a display interface of the terminal device; receiving a selection operation by a user on the at least one type of data, and obtaining user data corresponding to a type of data selected by the user; and backuping the user data corresponding to the type of data selected by the user into the data retention partition.

3. The terminal device according to claim 1, wherein the backuping the user data in the formatted partition into the data retention partition comprises: obtaining preset types of data to be backed up; determining the user data to be backed up, in the formatted partition according to the types of data to be backed up; and backuping the user data to be backed up, into the data retention partition.

4. The terminal device according to claim 1, wherein the formatting the formatted partition to delete the user data in the formatted partition comprises: obtaining path information of the formatted partition; and formatting the user data partition according to the path information of the formatted partition to delete the user data in the formatted partition.

5. The terminal device according to claim 1, wherein the processing the user data in the data retention partition using the target version comprises: determining a data format of user data to be processed in compatibility, which are any user data in the data retention partition; determining a database corresponding to the user data to be processed in compatibility, in the target version of the software system according to the data format; and extracting a keyword from the user data to be processed in compatibility, and inserting the keyword into the database in a format of the database.

6. The terminal device according to claim 1, wherein the one or more processors are further configured to execute the one or more computer readable program codes for deleting the user data in the data retention partition after the processed data are stored into the formatted partition.

7. A terminal device, comprising:
a partitioning module configured to partition a user data partition of the terminal device into a formatted partition and a data retention partition upon reception of an upgrade instruction to upgrade a current version of a software system of the terminal device;
a backup module configured to backup user data in the formatted partition into the data retention partition;
a formatting module configured to format the formatted partition to delete the user data in the formatted partition, after the user data in the formatted partition are backed up into the data retention partition;
an upgrading module configured to obtain an upgrade package corresponding to a target version of the software system, and to upgrade the current version of the software system of the terminal device to the target version using the upgrade package after the user data in the formatted partition are deleted; and
a compatibility-processing module configured to process compatibility of user data in the data retention partition using the target version so that processed user data are compatible with the target version, and to store the processed user data into the formatted partition.

8. The terminal device according to claim 7, wherein the backup module configured to backup the user data in the formatted partition into the data retention partition is configured:
to obtain at least one type of data stored in the formatted partition;
to display the at least one type of data on a display interface of the terminal device for selection by a user;
to receive a selection operation by the user on the at least one type of data, and to obtain user data corresponding to a type of data selected by the user; and
to backup the user data corresponding to the type of data selected by the user into the data retention partition.

9. The terminal device according to claim 7, wherein the backup module configured to backup the user data in the formatted partition into the data retention partition is configured:
to obtain preset types of data to be backed up;
to determine the user data to be backed up, in the formatted partition according to the types of data to be backed up; and
to back up the user data to be backed up, into the data retention partition.

10. The terminal device according to claim 7, wherein the formatting module configured to format the formatted partition is configured:
to obtain path information of the formatted partition; and
to format the formatted partition according to the path information of the formatted partition to delete the user data in the formatted partition.

11. The terminal device according to claim 7, wherein the compatibility-processing module configured to process compatibility of the user data in the data retention partition is configured:
to determine a data format of user data to be processed in compatibility, which are any user data in the data retention partition;
to determine a database corresponding to the user data to be processed in compatibility, in the target version of the software system according to the data format; and
to extract a keyword from the user data to be processed in compatibility, and to insert the keyword into the database in a format of the database.

12. The terminal device according to claim 7, further comprising:
a deleting module configured to delete the user data in the data retention partition after the processed data are stored into the formatted partition.

13. A version upgrading method applicable to a terminal device, the method comprises:
partitioning a user data partition of the terminal device into a formatted partition and a data retention partition upon reception of an upgrade instruction to upgrade a current version of a software system of the terminal device, wherein the user data partition is configured to store user data;
backuping user data in the formatted partition into the data retention partition, and formatting the formatted partition to delete the user data in the formatted partition;
obtaining an upgrade package corresponding to a target version of the software system, and upgrading the current version of the software system of the terminal device to the target version using the upgrade package; and
processing compatibility of the user data in the data retention partition using the target version so that processed user data are compatible with the target version, and storing the processed user data into the formatted partition.

14. The method according to claim 13, wherein the backuping the user data in the formatted partition into the data retention partition comprises:
obtaining at least one type of data stored in the formatted partition;
displaying the at least one type of data on a display interface of the terminal device;
receiving a selection operation by a user on the at least one type of data, and obtaining user data corresponding to a type of data selected by the user; and
backuping the user data corresponding to the type of data selected by the user into the data retention partition.

15. The method according to claim 13, wherein the backuping the user data in the formatted partition into the data retention partition comprises:
obtaining preset types of data to be backed up;
determining the user data to be backed up, in the formatted partition according to the types of data to be backed up; and
backuping the user data to be backed up, into the data retention partition.

16. The method according to claim 13, wherein the formatting the formatted partition so that the user data in the formatted partition are deleted comprises:
obtaining path information of the formatted partition; and
formatting the formatted partition according to the path information of the formatted partition to delete the user data in the formatted partition.

17. The method according to claim 13, wherein the processing compatibility of the user data in the data retention partition using the target version comprises:
determining a data format of the user data to be processed in compatibility, which are any user data in the data retention partition;
determining a database corresponding to the user data to be processed in compatibility, in the target version of the software system according to the data format; and
extracting a keyword from the user data to be processed in compatibility, and inserting the keyword into the database in a format of the database.

18. The method according to claim 13, wherein after the processed data are stored into the formatted partition, the method further comprises:
deleting the user data in the data retention partition.
